(19) United States
(12) Patent Application Publication
(10) Pub. No.: US 2013/0201116 A1
(43) Pub. Date: Aug. 8, 2013

(54) TOUCH PANEL

(71) Applicant: Hsueh-Jung Huang, New Taipei City (TW)

(72) Inventor: Hsueh-Jung Huang, New Taipei City (TW)

(21) Appl. No.: 13/440,935

(22) Filed: Apr. 5, 2012

(30) Foreign Application Priority Data
Feb. 7, 2012 (TW) 101103934

(51) Int. Cl. G06F 3/041

(52) U.S. Cl. 345/173

(57) ABSTRACT

A touch panel includes a substrate, at least one first axis sensing electrode, at least one second axis sensing electrode, and a compensating pattern. The substrate has a top surface and a bottom surface disposed oppositely to each other. The first axis sensing electrode and the second axis sensing electrode are disposed on the top surface of the substrate. A slit exists between the first axis sensing electrode and the second axis sensing electrode. The compensating pattern is disposed on the bottom surface of the substrate. The compensating pattern at least partially overlaps the slit between the first axis sensing electrode and the second axis sensing electrode in a vertical projective direction.

### BACKGROUND OF THE INVENTION

1. Field of the Invention

The present invention relates to a touch panel, and more particularly, to a touch panel including a compensating pattern disposed on a backside of a substrate to improve an appearance quality of the touch panel.

2. Description of the Prior Art

In recent years, touch sensing technologies have developed flourishingly, and electronic products, such as mobile phones, tablet PCs, GPS navigator systems, laptop PCs, and desktop PCs, which have both the touch sensing function and the display function, are commercialized accordingly. There are many diverse technologies of touch panel, and the resistance touch technology, the capacitive touch technology and the optical touch technology are the main touch technologies in use. The capacitive touch technology has become the mainstream touch technology for the high-end and the mid-end consumer electronics, because the capacitive touch panel has advantages such as high precision, multi-touch property, better endurance, and higher touch resolution.

In the capacitive touch technology, transparent sensing electrodes are used to detect the variations of electrical capacitances around a touch point, and feedback signals are transmitted via connecting lines, which interconnect all of the transparent sensing electrodes along different axis directions to locate the touch points. In the conventional capacitive touch technology, the transparent sensing electrodes are made of transparent conductive materials such as indium tin oxide (ITO) which is a material with high refractive index and may still absorb some light. Therefore, a visual difference may be generated between a region with the transparent sensing electrodes and a region without the transparent sensing electrodes, an issue of visible transparent sensing electrodes may occur, and an appearance quality of the touch panel may accordingly be affected.

### SUMMARY OF THE INVENTION

It is one of the objectives of the present invention to provide a touch panel. A compensating pattern is disposed on a backside of a substrate, and the compensating pattern at least partially overlaps a slit between the sensing electrodes in a vertical projective direction in order to overcome the issue of visible sensing electrodes on the touch panel and to enhance the quality of the touch panel.

To achieve the purposes described above, a preferred embodiment of the present invention provides a touch panel. The touch panel includes a substrate, at least one first axis sensing electrode, at least one second axis sensing electrode, and a compensating pattern. The substrate has a top surface and a bottom surface disposed oppositely to each other. The first axis sensing electrode and the second axis sensing electrode are disposed on the top surface of the substrate. A slit exists between the first axis sensing electrode and the second axis sensing electrode. The compensating pattern is disposed on the bottom surface of the substrate. The compensating pattern at least partially overlaps the slit between the first axis sensing electrode and the second axis sensing electrode along a vertical projective direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 are schematic diagrams illustrating a touch panel according to a first preferred embodiment of the present invention.

FIG. 5 and FIG. 6 are schematic diagrams illustrating a touch panel according to a second preferred embodiment of the present invention.

FIG. 7 and FIG. 8 are schematic diagrams illustrating a touch panel according to a third preferred embodiment of the present invention.

FIG. 9 and FIG. 10 are schematic diagrams illustrating a touch panel according to a fourth preferred embodiment of the present invention.

### DETAILED DESCRIPTION

Certain terms are used throughout the description and following claims to refer to particular components. As one skilled in the art will understand, electronic equipment manufacturers may refer to a component by different names. This document does not intend to distinguish components that differ in name but not function. In the following description and in the claims, the term “include” is used in an open-ended fashion, and thus should be interpreted to mean “include, but not limited to . . . ” In addition, to simplify the descriptions and make it more convenient to compare embodiments between each other, identical components are marked with the same reference numerals in each of the following embodiments. Please note that the figures are only for illustration and the figures may not be to scale. Additionally, the terms such as “first” and “second” in this context are only used to distinguish different components and do not constrain the order of generation.

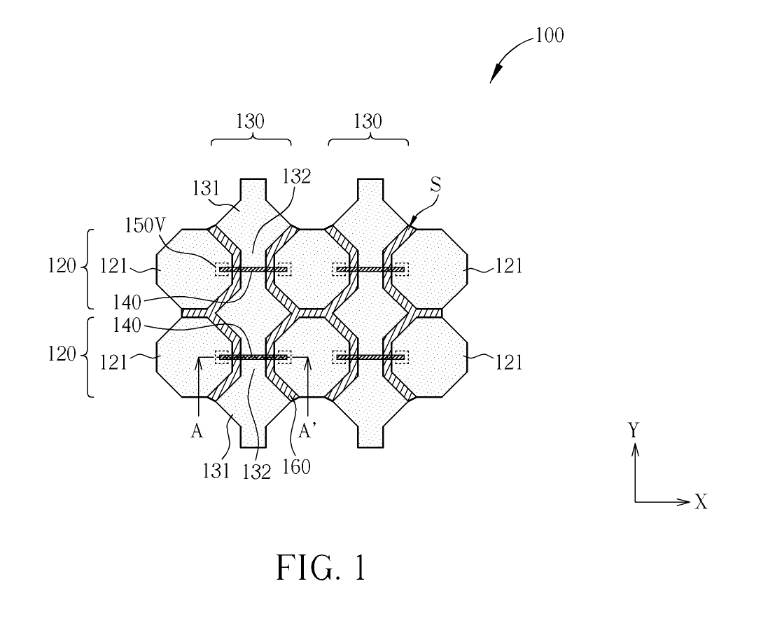

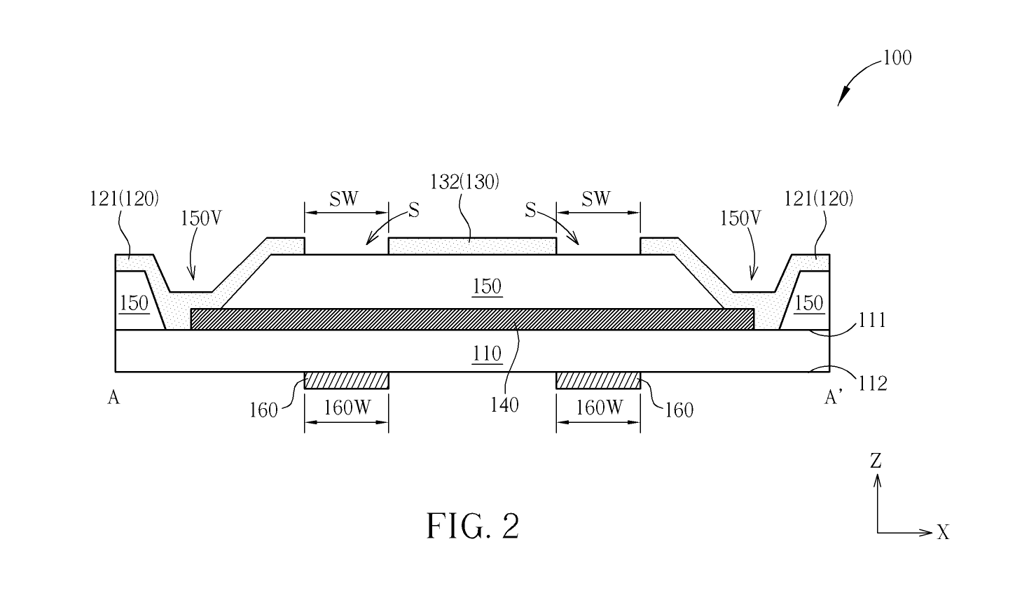

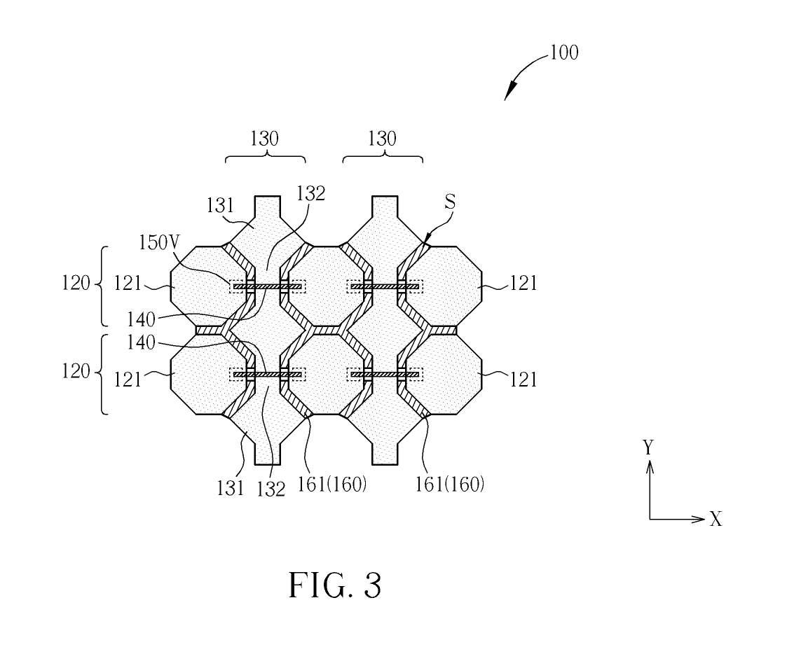

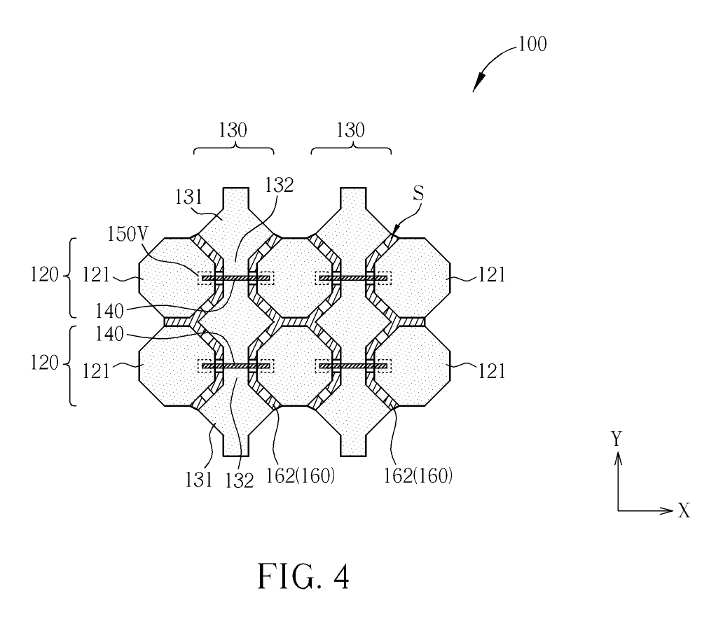

Please refer to FIGS. 1-4. FIGS. 1-4 are schematic diagrams illustrating a touch panel according to a first preferred embodiment of the present invention. FIG. 1 is a top-view diagram. FIG. 2 is a cross-sectional view diagram taken along cross-sectional line A-A′ in FIG. 1. FIG. 3 illustrates another exemplary embodiment of a compensating pattern, and FIG. 4 illustrates further another exemplary embodiment of a compensating pattern. Please note that the figures are only for illustration and the figures may not be to scale. The scale may be further modified according to different design considerations. As shown in FIG. 1 and FIG. 2, the first preferred embodiment of the present invention provides a touch panel 100. The touch panel 100 includes a substrate 110, a plurality of first axis sensing electrodes 120, a plurality of second axis sensing electrodes 130, a protection layer 150, a plurality of first connecting lines 140, and a compensating pattern 160. The substrate 110 has a top surface 111 and a bottom surface 112 disposed oppositely to each other. The first axis sensing electrodes 120, the second axis sensing electrodes 130, the protection layer 150, and the first connecting lines 140 are disposed on the top surface 111 of the substrate 110. A slit S exists between the first axis sensing electrode 120 and the second axis sensing electrode 130. The compensating pattern 160 is disposed on the bottom surface 112 of the substrate 110, and the compensating pattern 160 at least partially overlaps the slit S between the first axis sensing electrode 120 and the second axis sensing electrode 130 in a vertical projective direction Z in order to improve an appearance quality of the touch panel 100. The vertical projective direction Z in this embodiment is preferably perpendicular to the substrate 110, but not limited thereto. It is worth noting that the compensating pattern 160 of the present invention is disposed on a surface different from the one where the first axis sensing electrodes 120 and the second axis sensing electrodes 130 are disposed on, and the appearance quality may be accordingly enhanced. Additionally, a capacitance condition of the first axis sensing electrodes 120 and the second axis sensing electrodes 130 may not be influenced by the compensating pattern 160, and an interference in computing within a controlling integrated circuit (not shown) of the touch panel 100 may become minor.

For further description, the substrate 110 in this embodiment may preferably include rigid substrates such as glass substrates or ceramic substrates, flexible substrates such as plastic substrates, or other substrates made of appropriate materials. The first axis sensing electrodes 120 and the second axis sensing electrodes 130 may preferably include transparent conductive materials such as indium tin oxide (ITO), indium zinc oxide (IZO), or aluminum zinc oxide (AZO), but not limited thereto. Each of the first axis sensing electrodes 120 includes a plurality of first sensing pads 121 disposed along a first direction X, and each of the second axis sensing electrodes 130 includes a plurality of second sensing pads 131 disposed along a second direction Y. The first direction X is preferably perpendicular to the second direction Y, but not limited thereto. Additionally, each of the first connecting lines 140 is used to electrically connect two adjacent first sensing pads 121 in the first direction X. Comparatively, each of the second axis sensing electrodes 130 includes a plurality of second connecting lines 132, and each of the second connecting lines 132 is used to electrically connect two adjacent second sensing pads 131 in the second direction Y. A touch sensing function may be established by the first axis sensing electrodes 120 and the second axis sensing electrodes 130 disposed interlacedly to each other. In other words, the touch panel 100 in this embodiment may be a capacitive touch panel, but not limited thereto. It is worth noting that the first connecting lines 140 may preferably include transparent conductive materials such as indium tin oxide, indium zinc oxide, and aluminum zinc oxide, or other appropriate non-transparent conductive materials such as silver (Ag), aluminum (Al), copper (Cu), magnesium (Mg), molybdenum (Mo), a stack layer of the above-mentioned materials, or an alloy of the above-mentioned materials, but not limited thereto. Additionally, the second connecting lines 132 and the second sensing pads 131 are preferably formed simultaneously by an identical conductive material, and the related processes may be accordingly simplified, but the present invention is not limited to this and the second connecting lines 132 and the second sensing pads 131 may also be formed by different materials. The protection layer 150 is disposed between the first connecting lines 140 and the second connecting lines 132 to electrically insulate the first connecting lines 140 from the second connecting lines 132. The protection layer 150 has a plurality of contact holes 150V, and each of the contact holes 150V partially exposes the first connecting lines 140 respectively. Each of the first sensing pads 121 is electrically connected to the corresponding first connecting lines 140 through the contact holes 150V. The protection layer 150 in this embodiment may include inorganic materials such as silicon nitride, silicon oxide, and silicon oxynitride, organic materials such acrylic resin, or other appropriate materials.

In this embodiment, for improving the appearance quality of the touch panel 100, a refractive index of the compensating pattern 160 is preferably equal to a refractive index of the first axis sensing electrode 120, and the refractive index of the compensating pattern 160 is preferably equal to a refractive index of the second axis sensing electrode 130. In addition, the compensating pattern 160 may preferably include transparent conductive materials such as indium tin oxide, indium zinc oxide, or aluminum zinc oxide, but not limited thereto. In other words, the compensating pattern 160, the first axis sensing electrodes 120, and the second axis sensing electrodes 130 are preferably made of an identical transparent conductive material, but the present invention is not limited to this. In another preferred embodiment of the present invention, the compensating pattern 160 may also be made of a material with a refractive index different from the refractive index of the first axis sensing electrode 120 and the second axis sensing electrode 130, and the appearance quality of the touch panel 100 may be improved by modifying a thickness of the compensating pattern 160. Additionally, a width 160W of the compensating pattern 160 may be preferably equal to a width SW of the slit S, and the influence of the slit S on the appearance quality may be accordingly compensated. It is worth noting that the compensating pattern 160 of this embodiment is disposed on a different surface from the one where the first axis sensing electrodes 120 and the second axis sensing electrodes 130 are disposed on, and the compensating pattern 160 is preferably a floating pattern. In other words, the compensating pattern 160 is electrically insulated from the first axis sensing electrodes 120, the second axis sensing electrodes 130, and other components. The electrical properties of the touch panel 100 under touch operations may accordingly not be influenced by the compensating pattern 160.

As shown in FIG. 1 and FIG. 2, the compensating pattern 160 in this embodiment completely overlaps the slit S between the first axis sensing electrode 120 and the second axis sensing electrode 130 in the vertical projective direction Z, but the present invention is not limited to this. For example, as shown in FIG. 3 and FIG. 4, the compensating pattern 160 may include a plurality of sub compensating patterns 161 or a plurality of sub compensating patterns 162 in another exemplary embodiment and further another exemplary embodiment. The sub compensating patterns 161 are structurally separated from each other, and the sub compensating patterns 162 are structurally separated from each other. In other words, the sub compensating patterns 161 and the sub compensating patterns 162 partially overlap the slit S between the first axis sensing electrode 120 and the second axis sensing electrode 130 in the vertical projective direction Z to improve the appearance quality of the touch panel 100.

The following description will detail the different embodiments of the touch panel in the present invention. To simplify the description, the identical components in each of the following embodiments are marked with identical symbols. For making it easier to understand the differences between the embodiments, the following description will detail the dissimilarities among different embodiments and the identical features will not be redundantly described.

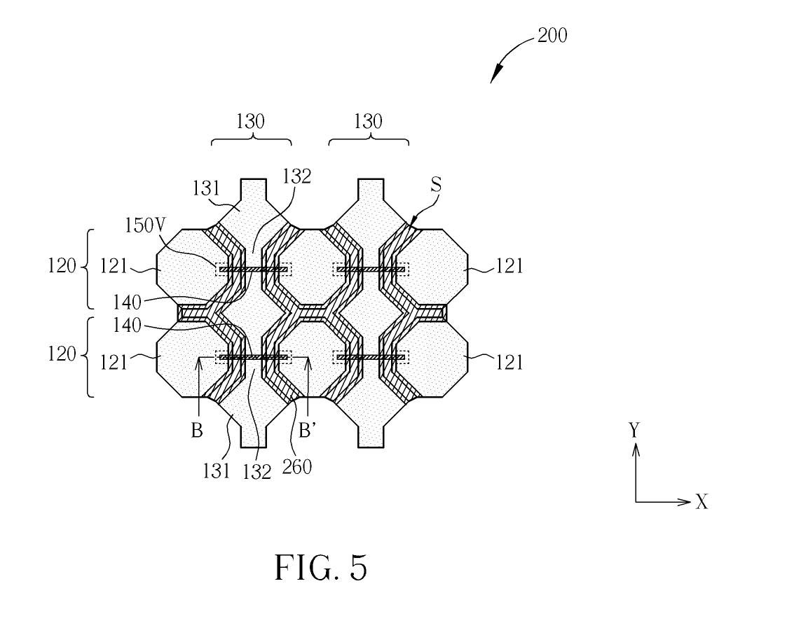

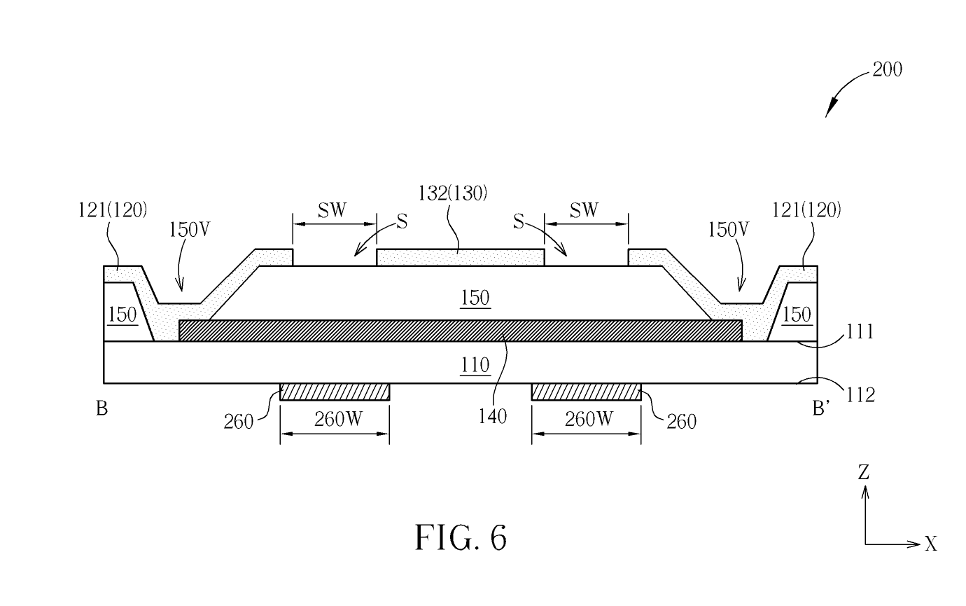

Please refer to FIG. 5 and FIG. 6. FIG. 5 and FIG. 6 are schematic diagrams illustrating a touch panel 200 according to a second preferred embodiment of the present invention. FIG. 5 is a top-view diagram. FIG. 6 is a cross-sectional view diagram taken along cross-sectional line B-B′ in FIG. 5. As shown in FIG. 5 and FIG. 6, the touch panel 200 in this embodiment includes a substrate 110, a plurality of first axis sensing electrodes 120, a plurality of second axis sensing electrodes 130, a protection layer 150, a plurality of first connecting lines 140, and a compensating pattern 260. The difference between the touch panel 200 of this embodiment and the touch panel 100 of the first preferred embodiment is that a width 260W of the compensating pattern 260 is preferably larger than a width SW of the slit S to ensure that the compensating pattern 260 completely overlaps the slit S in the vertical projective direction Z even if mis-alignments occur in the manufacturing process. Apart from the compensating pattern 260 in this embodiment, the other components, allocations and material properties of this embodiment are similar to those of the first preferred embodiment detailed above and will not be redundantly described.

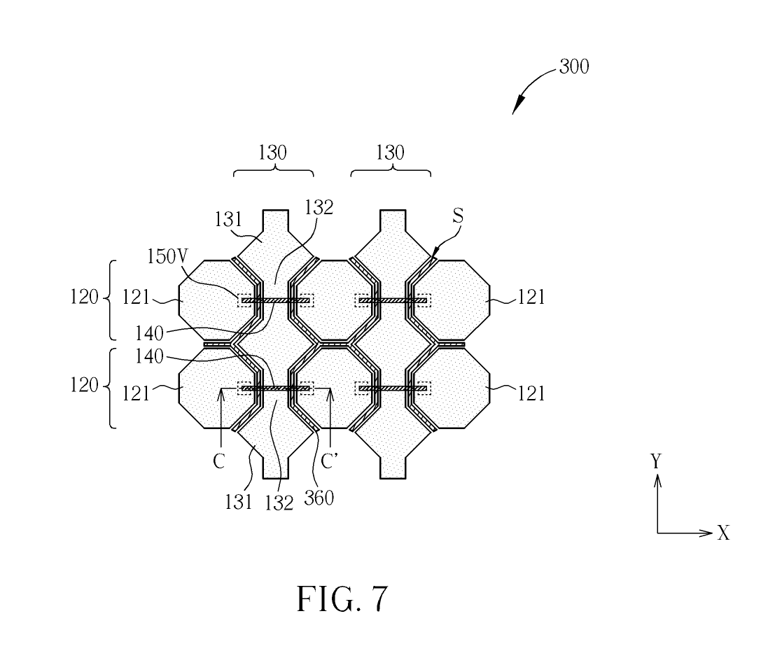

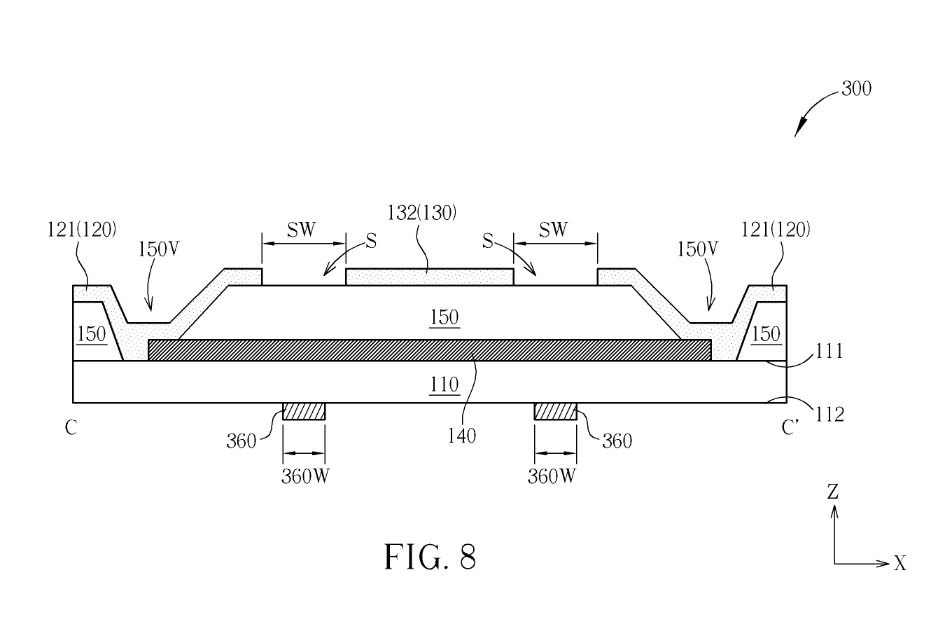

Please refer to FIG. 7 and FIG. 8. FIG. 7 and FIG. 8 are schematic diagrams illustrating a touch panel 300 according to a third preferred embodiment of the present invention. FIG. 7 is a top-view diagram. FIG. 8 is a cross-sectional view diagram taken along cross-sectional line C-C′ in FIG. 7. As shown in FIG. 7 and FIG. 8, the touch panel 300 in this embodiment includes a substrate 110, a plurality of first axis sensing electrodes 120, a plurality of second axis sensing electrodes 130, a protection layer 150, a plurality of first connecting lines 140, and a compensating pattern 360. The difference between the touch panel 300 of this embodiment and the touch panel 100 of the first preferred embodiment is that a width 360W of the compensating pattern 360 is preferably smaller than a width SW of the slit S. In other words, the compensating pattern 360 partially overlaps the slit S in the vertical projective direction Z to improve the appearance quality of the touch panel 300. Apart from the compensating pattern 360 in this embodiment, the other components, allocations and material properties of this embodiment are similar to those of the first preferred embodiment detailed above and will not be redundantly described.

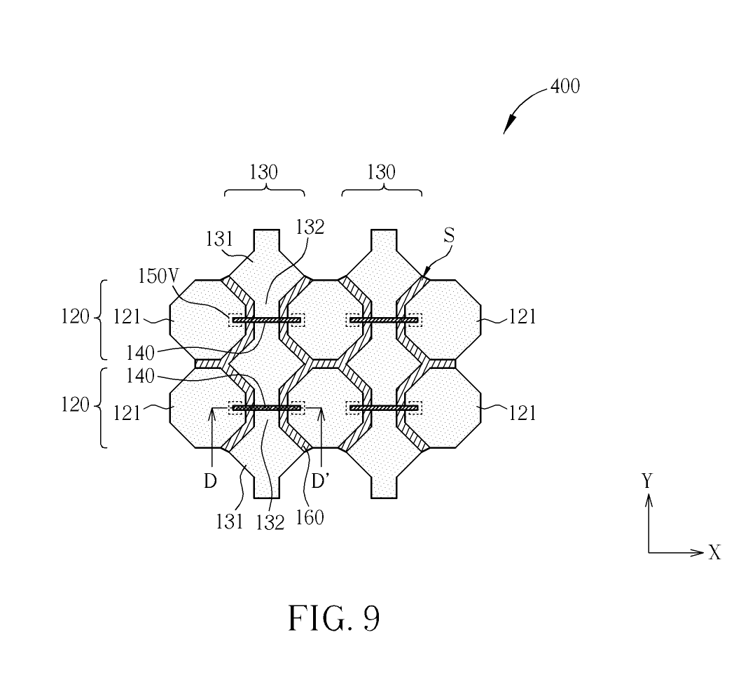

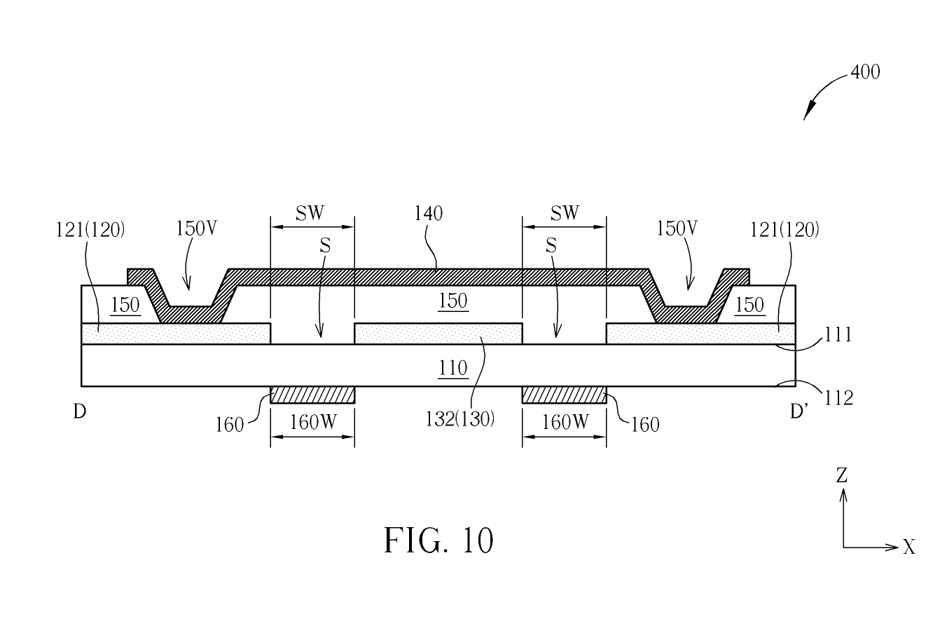

Please refer to FIG. 9 and FIG. 10. FIG. 9 and FIG. 10 are schematic diagrams illustrating a touch panel 400 according to a fourth preferred embodiment of the present invention. FIG. 9 is a top-view diagram. FIG. 10 is a cross-sectional view diagram taken along cross-sectional line D-D′ in FIG. 9. As shown in FIG. 9 and FIG. 10, the difference between the touch panel 400 of this embodiment and the touch panel 100 of the first preferred embodiment is that the first axis sensing electrodes 120 and the second axis sensing electrodes 130 are disposed between the protection layer 150 and the substrate 110. In other words, the first axis sensing electrodes 120 and the second axis sensing electrodes 130 are formed on the top surface 111 of the substrate 110 before forming the protection layer 150 and the first connecting lines 140. Each of the first connecting lines 140 is electrically connected to the corresponding first sensing pad 121 through the contact holes 150V. Apart from the allocation of the first axis sensing electrodes 120, the second axis sensing electrodes 130, and the first connecting lines 140 in this embodiment, the other components and material properties of this embodiment are similar to those of the first preferred embodiment detailed above and will not be redundantly described.

To summarize the above descriptions, in the touch panel of the present invention, the sensing electrodes are disposed on the top surface of the substrate and the compensating pattern is disposed on the bottom surface of the substrate. The compensating pattern at least partially overlaps the slit between the first axis sensing electrode and the second axis sensing electrode in the vertical projective direction to overcome the issue of visible sensing electrodes. Additionally, the electrical properties of the touch panel under touch operations may accordingly not be influenced by the compensating pattern because the compensating pattern is disposed on a different surface from the one where the first axis sensing electrodes and the second axis sensing electrodes are disposed on. The quality of the touch panel may be accordingly enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate, having a top surface and a bottom surface disposed oppositely to each other;
at least one first axis sensing electrode, disposed on the top surface of the substrate;
at least one second axis sensing electrode, disposed on the top surface of the substrate, wherein a slit exists between the first axis sensing electrode and the second axis sensing electrode; and
a compensating pattern, disposed on the bottom surface of the substrate; wherein the compensating pattern at least partially overlaps the slit between the first axis sensing electrode and the second axis sensing electrode in a vertical projective direction.

2. The touch panel of claim 1, wherein the compensating pattern comprises a floating pattern.

3. The touch panel of claim 1, wherein a refractive index of the compensating pattern is equal to a refractive index of the first axis sensing electrode, and the refractive index of the compensating pattern is equal to a refractive index of the second axis sensing electrode.

4. The touch panel of claim 1, wherein a width of the compensating pattern is equal to a width of the slit.

5. The touch panel of claim 1, wherein a width of the compensating pattern is larger than a width of the slit.

6. The touch panel of claim 1, wherein a width of the compensating pattern is smaller than a width of the slit.

7. The touch panel of claim 1, wherein the compensating pattern completely overlaps the slit between the first axis sensing electrode and the second axis sensing electrode in the vertical projective direction.

8. The touch panel of claim 1, wherein the compensating pattern comprises a plurality of sub compensating patterns, and the sub compensating patterns are separated from each other.

9. The touch panel of claim 1, wherein the compensating pattern, the first axis sensing electrode, and the second axis sensing electrode comprise a transparent conductive material respectively.

10. The touch panel of claim 1, wherein the compensating pattern is electrically insulated from the first axis sensing electrode and the second axis sensing electrode.
